(19) United States
(12) Patent Application Publication
(10) Pub. No.: US 2011/0007631 A1
(43) Pub. Date: Jan. 13, 2011

(54) Network Communication

(76) Inventors: Gaurav Raina, Chennai (IN); Francis Patrick Kelly, Cambridge (GB); Thomas Voice, Cambridge (GB)

Correspondence Address: Rahman LLC, 10025 Governor Warfield Parkway, Suite 110, Columbia, MD, 21044, US

(21) Appl. No.: 12/920,107

(22) PCT Filed: Feb. 26, 2009
(86) PCT No.: PCT/IN2009/000127

§ 371 Date: Aug. 28, 2010

(30) Foreign Application Priority Data
Feb. 29, 2008 (GB) 0803788.9

(51) Int. Cl. H04L 12/56; H04L 12/26

(52) U.S. Cl. 370/230; 370/235; 370/238; 370/401

(57) ABSTRACT

The invention relates to methods and processes of congestion control for a communication network which may be designed to be compatible with a wide variety of buffer sizing regimes, particularly small buffers, for routers in the network. Each router may include a processor configured to store an internal feedback variable indicative of an aggregate flow rate of all data flows at the router; detect a new data flow to the router; determine any required adjustment to the internal feedback variable and to the flow rates of existing data flows at the router to accommodate the new flow at a defined flow rate; adjust the internal feedback variable, responsive to the determining step; and communicate the defined flow rate to the source of the new flow and the adjusted flow rates to sources of existing data flows.

### FIELD OF THE INVENTION

The invention relates to communication networks, in particular, methods and processes for network congestion control.

### BACKGROUND TO THE INVENTION

A communication network may comprise of a set of traffic source nodes connected to destination nodes via a series of interlinked resources such as routers, switches, wireless connections, physical wires, etc. To facilitate desirable and efficient network performance, it is often required to implement control mechanisms for the management of network congestion.

Examples of a communication network include a local area network (LAN), wide area network (WAN), wireless network, mixed device network or other classifications of network.

There is currently considerable interest in explicit congestion control protocols which use a field in each packet to convey relatively concise information on congestion from resources to endpoints. These protocols contrast with TCP and its various enhancements where endpoints implicitly estimate congestion from noisy information, essentially the single bit of feedback provided by a dropped or marked packet. Examples of explicit congestion control protocols include XCP (see Dina Katabi, Mark Handley, and Charlie Rohrs. Congestion control for high bandwidth-delay product networks. {Proc. ACM Sigcomm}, 2002) and RCP (see Hamsa Balakrishnan, Nandita Dukkipati, Nick Mckeown, and Claire Tomlin. Stability analysis of explicit congestion control protocols. {volume 11, number 10, pp. 823-825, IEEE Communications Letters}, 2007).

RCP updates its estimate of a fair rate through a single bottleneck link from observations of the spare capacity at the link and the queue size as described by the following equation:

$$\frac{d}{d t} R ( t ) = \frac{R ( t )}{C \overline{T}} ( a ( C - y ( t ) ) - β \frac{q ( t )}{\overline{T}} )$$

$$where$$

$$y ( t ) = {\sum }_{s} R ( t - {T}_{s} )$$

$$and$$

$$\begin{matrix}\frac{d}{d t} q ( t ) = [ y ( t ) - C ] & q ( t ) > 0 \\ = {[ y ( t ) - C ]}^{+} & q ( t ) = 0 ,\end{matrix}$$

using the notation x⁺=max (0,x). Here R(t) is the rate being updated by the router, C is the link capacity, y(t) is the aggregate load at the link, q(t) is the queue size, Tₛ is the round-trip time of flow s, and T̅ is the average round-trip time, over the flows present.

The first relation contains two forms of feedback—a term based on the rate mismatch C−y(t) and a term based on the instantaneous queue size q(t).

Sufficient conditions for local stability of the system about its equilibrium point were derived in Balakrishnan et al. “Stability analysis of explicit congestion control protocols” Standford University Department of Aeronautics and Astronautics Report: SUDAAR 776. September 2005. The paper uses results for a switched linear control system with a time delay. The analysis explicitly models the discontinuity in the system dynamics that occurs as the queue becomes empty. The sufficient conditions, on the non-negative dimensionless constants a and α and β, take the form

$$a < \frac{π}{2}$$

and β<ƒ(α) where f is a positive function that depends on T̅.

Router buffer sizing is an important issue for explicit congestion control protocols, as also for other protocols like TCP. The buffer in a router serves to accommodate transient bursts in traffic, without having to drop packets. However, it also introduces queuing delay and jitter. Arguably, router buffers are one of the biggest sources of uncertainty in a communications network and the design of congestion control algorithms that address this issue is an extremely challenging problem facing the research community.

The capacities of routers are limited by the buffers they must use to hold packets. Buffers are currently sized using a rule of thumb which says that each link needs a buffer of size B= T̅*C, where T̅ is the average round-trip time of the flows passing across the link, and C is the data rate of the link. For example, a 10 Gb/s router line card needs approximately 250 ms * 10 Gb/s=2.5 Gbits of buffers, enough to hold roughly 200 k packets. In practice, a typical 10 GB/s router linecard can buffer one million packets. It is safe to say that the speed and size of buffers is the single biggest limitation to growth in router capacity today, and it represents a significant challenge to router vendors.

A major outstanding issue is the processes involved in admitting new flows into a communication network so that the new flows get a high starting rate. In this regard, the size of buffers is of immediate practical importance. If links are run at near full capacity, then in order to give new flows a high starting rate without resulting in a significant loss of packets caused by buffer overflow, buffers would need to be large. If links are run with some spare capacity then this may help to cope with new flows demanding a high starting rate, and hence may allow buffers to be somewhat smaller than the buffer dimensioning rule of thumb mentioned above. However, it would be greatly valuable to be able to implement a process of admitting new flows that does not require buffer sizing rules to depend on network parameters like capacity and round-trip times.

### STATEMENTS OF INVENTION

According to one aspect of the invention, there is provided a router for a communication network comprising at least one source and at least one destination with a plurality of data flows from said at least one source to said at least one destination, said router comprising a processor which is configured to store local information relating to said router at said router; determine, using said stored local information, an internal feedback variable indicative of congestion at said router; detect a new data flow to the router; determine, using said stored local information and said internal feedback variable, an adjustment to said internal feedback variable to accommodate said new flow; and communicate data representing said adjusted internal feedback variable to said source of said new flow and to sources of existing data flows, whereby said sources of existing data flows adjust their flow rates so that there is a reduction in the aggregate flow rate of sources of existing data flows to accommodate said new flow.

According to another aspect of the invention, there is provided a method of managing flow through a router on a communication network comprising at least one source and at least one destination with a plurality of data flows from said at least one source to said at least one destination, said method comprising storing local information relating to said router at said router; determining, using said stored local information, an internal feedback variable indicative of congestion at said router; detecting a new data flow to the router; determining, using said stored local information and said internal feedback variable, an adjustment to said internal feedback variable to accommodate said new flow; and communicating data representing said adjusted internal feedback variable to said source of said new flow and to sources of existing data flows, whereby said sources of existing data flows adjust their flow rates so that there is a reduction in the aggregate flow rate of sources of existing data flows to accommodate said new flow.

The sources of existing data flows at said router may be adjacent routers or sources from which a data flow originates.

Said local information may include a variety of possible flow statistics and the flow statistics may be determined without knowledge of individual flow rates. An estimate of a function of the aggregate flow rate could be calculated, by taking a weighted exponential average of packet arrivals at said router, or by using a fixed proportion of the bandwidth of said router, for example. The flow statistics could include a function of mean queue length for the buffer at said router or a virtual queue maintained at said router. The flow statistics could also include known parameters taken from the underlying congestion control processes. Alternatively, certain statistics could be derived by having traffic sources include information in packet headers which could then be aggregated at the router, by taking a moving exponential average, for example. Furthermore by observing the changes in flow statistics that follow changes in the internal feedback variable, the responsiveness of a flow statistic to said changes may be estimated and used as a further flow statistic.

The internal feedback variable is a variable which is specific and internal to each router and may be determined from information from said router without reference to other elements of said communication network. The internal feedback variable is preferably some form of feedback information provided by the router as part of an underlying network congestion control scheme. For example, this feedback information could be explicit congestion feedback communicated to sources via packet headers, or more implicit feedback, such as a probability of dropping a packet at a link. The internal feedback variable or a transformed version of the feedback variable may be stored at said router.

The internal feedback variable may be defined with reference to the congestion protocol being used in the network. For example, for a network with multiple links, there exist several possible generalizations of the RCP model which was defined in the background section. These generalizations lead to a family of different equilibrium structures which allocate resources according to different notions of fairness. Max-min is the fairness criterion commonly envisaged in connection with RCP, but it not the only possibility. An alternative congestion protocol which is a generalization of RCP, and which results in a family of fairness criteria, of which max-min is a limiting case, is set out below.

We consider a network with a set J of resources. Each source r has associated with it a non-empty subset of J, describing the route that traffic from r takes through the network. We write jεr, to indicate that traffic from source r passes through resource j.

For each j, r such that jεr let Tᵣⱼ be the propagation delay from the time a packet leaves source r to the time it passes through the resource j, and let _{T}ⱼᵣ be the return delay from the packet leaving resource j to the arrival at r of congestion feedback from j. Then

Tᵣⱼ+Tⱼᵣ=Tᵣjεr,rεR,

where Tᵣ is the round-trip propagation delay for source r: the identity above is a direct consequence of the end-to-end nature of the signalling mechanism, whereby congestion on a route is conveyed via a field in the packets to the destination, which then informs the source.

For each resource j let us define Rⱼ(t) to be an internal variable maintained by j.

Consider the following system of differential equations which models the evolution of these internal variables under a rate control protocol

$$\frac{d}{d t} {R}_{j} ( t ) = \frac{{aR}_{j} ( t )}{{C}_{j} {\overline{T}}_{j} ( t )} ( {C}_{j} - {y}_{j} ( t ) )$$

$$where$$

$${y}_{j} ( t ) = {\sum }_{r : j ∈ r} {x}_{r} ( t - {T}_{rj} )$$

is the aggregate load at link j, and

$${\overline{T}}_{j} ( t ) = \frac{{\sum }_{r \text{:} j ∈ r} {x}_{r} ( t ) {T}_{r}}{{\sum }_{r \text{:} j ∈ r} {x}_{r} ( t )}$$

is the average round-trip time of packets passing through resource j. We suppose the flow rate xᵣ is given by

$${x}_{r} ( t ) = {{w}_{r} ( {\sum }_{j ∈ r} {{R}_{j} ( t - {T}_{jr} )}^{- α} )}^{- 1 / α} .$$

At the equilibrium point y=(yⱼ, jεJ) for the dynamical system defined by the above four equations we have Cⱼ−yⱼ=0. A sufficient condition for the local stability of this equilibrium point is ensured if the constant α<π/2.

Observe that, as α→∞, the final expression approaches min_{jεr}(Rⱼ(t−Tⱼᵣ)), corresponding to max-min fairness. In general, the flows at equilibrium will be weighted α-fair with weights wᵣ. For uniformity of exposition, we term the above version of RCP as α Fair RCP.

Note that for bounded values of α, the computation of the above expression can be performed as in the following manner: if a packet is served by link j at time t, R ⱼ(t)^{-α} is added to the field in the packet containing the indication of congestion. When an acknowledgement is returned to its source, the acknowledgement reports the sum, and the source sets its flow rate equal to the returning feedback to the power of −1/α.

The above generalized RCP model is closely related to the fair dual algorithm (see F Kelly “Fairness and stability of end-to-end congestion” European Journal of Control, 9:159-176, 2003) in which for each resource j there is an internal feedback variable maintained by j, defined as μⱼ(t). The following system of differential equations models the evolution of these internal feedback variables

$$\frac{d}{d t} {μ}_{j} ( t ) = {κ}_{j} {μ}_{j} ( t ) ( {C}_{j} - {y}_{j} ( t ) )$$

$$where$$

$${y}_{j} ( t ) = {\sum }_{r : j ∈ r} {x}_{r} ( t - {T}_{rj} )$$

is the aggregate load at link j and κ is the gain parameter at the resource. We suppose the flow rate xᵣ is given by

$${x}_{r} ( t ) = {{w}_{r} ( {\sum }_{j ∈ r} {{μ}_{j} ( t - {T}_{jr} )}^{- α} )}^{- 1 / α} .$$

For the same values of α, both models have the same equilibrium structure for the xᵣ, that of weighted α-fairness with weights wᵣ.

For bounded values of α the third computation above can be performed as follows If a packet is served by link j at time t, μⱼ(t) is added to the field in the packet containing the indication of congestion. When an acknowledgement is returned to its source, the acknowledgement feedbacks the sum, and the source sets its flow rate equal to the returning feedback to the power of −1/α. Note that in the version of RCP above, the equivalent to the internal feedback variable μⱼ(t) is Rⱼ(t)^{-α}.

At the equilibrium point y=(yⱼ, jεJ) for the dynamical system we have Cⱼ−yⱼ=0 .

A sufficient condition to ensure local stability of this equilibrium point is κⱼCⱼ T̅ⱼ(t)<απ/2 for all j, where

$${\overline{T}}_{j} ( t ) = \frac{{\sum }_{r \text{:} j ∈ r} {x}_{r} ( t ) {T}_{r}}{{\sum }_{r \text{:} j ∈ r} {x}_{r} ( t )}$$

is the average round-trip time of packets passing through resource j.

In the above models Cⱼ may be a constant taken to be the resource capacity at link j, or alternatively the above algorithms may use a smaller virtual capacity to set a desired target level of equilibrium utilization. As the above discussion highlights, there may be several different models for an explicit congestion controlled network which may result in different forms of fairness at equilibrium.

Communication protocols that use explicit feedback from routers may be able to achieve fast convergence to an equilibrium that approximates processor-sharing on a single bottleneck link and hence allows flows to complete quickly. For a general network, processor-sharing is not uniquely defined. Indeed, there are several possibilities corresponding to different choices of fairness criterion which give rise to a family of equilibrium models.

The internal feedback variable may be defined as the inverse of an internal variable Rⱼ (t) where

$$\frac{d}{d t} {R}_{j} ( t ) = \frac{{aR}_{j} ( t )}{{C}_{j} {\overline{T}}_{j} ( t )} ( {C}_{j} - {y}_{j} ( t ) )$$

as set out above.

Alternatively, the internal feedback variable may be defined as μⱼ(t) where

$$\frac{d}{d t} {μ}_{j} ( t ) = {κ}_{j} {μ}_{j} ( t ) ( {C}_{j} - {y}_{j} ( t ) )$$

as set out above

The internal feedback variable may be stored after a transformation and this transformed value may be manipulated by the underlying congestion control process. For example, in the case of α Fair RCP, the feedback given to sources from a resource j is μⱼ(t)=Rⱼ(t)^{-α}. Although the router may store and manipulate Rⱼ(t) as an internal variable, we refer to Rⱼ(t)^{-α} as the internal feedback variable. For the case of the Fair Dual, the internal feedback variable is μⱼ(t).

When a new connection starts, the resource (or router) alters its internal feedback variable in order to provoke a reaction from said underlying congestion control scheme which reduces the aggregate flow rate through that resource, freeing up sufficient bandwidth for the new connection. This adjustment in the internal feedback variable may be achieved by adjusting a stored transformed version; for example, Rⱼ(t) in the α Fair RCP case.

The detecting step may include checking each packet of data flowing through the resource at some point, e.g. at arrival or upon service, to see whether it is the first packet of a source or connection. If it is not a new data flow, the resource continues with its normal process, updating the flow statistics where appropriate. If a new connection is detected, the internal feedback variable is adjusted.

When a new flow is detected, the adjustment to the internal feedback variable may be calculated by setting the internal feedback variable μ equal to μ^{new} some value μ^{new} which is a function of μ and the aggregate flow statistics maintained at the resource. The value of μ^{new} should be chosen so that the change in feedback provokes a reaction in the underlying congestion control processes which results in a reduction in aggregate flow through the resource, approximately sufficient to accommodate a new flow. One way to calculate an appropriate μ^{new} is to set μ^{new}=μ+Δμ, where Δμ is chosen so that

$$Δμ \frac{\partial y}{\partial μ}$$

is approximately equal to the expected amount of bandwidth required to accommodate a new flow. Here ∂y/∂μ represents the responsiveness of the aggregate flow y to changes in the internal feedback variable μ, according to the underlying congestion control scheme.

The value of ∂y/∂μ and the expected bandwidth of a new flow may not be known, so Δμ may be calculated from approximations. For example, suppose each source r has a flow rate equal to Dᵣ(λᵣ), for some function Dᵣ(·), where λᵣ is the aggregate congestion feedback along r. Then a resource j might approximate ∂y/∂μ with yD′(μ)/D(μ) where D(·) is a typical choice of Dᵣ(·). Alternatively, each source r could calculate and include D′ᵣ(λᵣ)/Dᵣ(λᵣ) in the header of each packet sent, then taking a moving exponential average of this quantity at a router j will yield an estimate of ∂y/∂μ.

The expected bandwidth of a new flow may be estimated in many ways, for example, a resource could use D(μ) for some function D(·). Alternatively, sources could communicate the inverse of their flow rates in packet headers. Taking a per packet average of this quantity at a resource j yields an estimate of the inverse of the average flow per source using j. Other techniques may also be used, such as choosing an estimate so it is equal to the predicted value of the quantity after the new flow has begun.

In the α Fair RCP model, if wᵣ is equal to 1 for all sources r then this corresponds to an unweighted α-fair flow distribution at equilibrium. When a α1, this distribution is proportionally fair. For the proportionally fair RCP case, on observation of a new flow, there may be an immediate a step-change in Rⱼ to a new value

$${R}_{j}^{new} = {R}_{j} \frac{{y}_{j}}{{y}_{j} + {R}_{j}} .$$

In the case of the fair dual with un-weighted flows, the step-change could be in μⱼ, taking μⱼ to be equal to μⱼ^{μ}=μⱼ(yⱼ+μⱼ⁻)/yⱼ.

A weight may be allocated to said new flow and/or to each existing flow, e.g. in networks where source flows are weighted for importance. The resource processor may be configured to determine the starting weight of the new flow. This may be achieved by starting all flows at the same weight or by flows declaring their starting weight during initialization connection. The resource may also be configured to detect if a source wishes to increase its flow weight, whereby the resource may signal the resources along its route of this change. The resource may communicate the changes, for example, by including any weight increases in a field in packet headers. Alternatively, if weights are always integers, a single bit in the field of packet headers may be indicative of an increase in weight of 1 and each resource may check this bit.

According to another aspect of the invention, there is provided a router for a communication network comprising at least one source and at least one destination with a plurality of data flows from said at least one source to said at least one destination, said router comprising a processor which is configured to store local information relating to said router at said router; determine, using said stored local information, an internal feedback variable indicative of congestion at said router; detect a change in a weight allocated to a data flow; determine, using said stored local information and said internal feedback variable, an adjustment to said internal feedback variable to accommodate said detected change; and communicate data representing said adjusted internal feedback variable to said sources, whereby said sources having unchanged weight adjust their flow rates so that there is a change in the aggregate flow rate allocated to said sources of data flows having unchanged weight to accommodate any change in flow rate corresponding to said detected change in weight.

Said detected change may be an increase in an allocated weight for an existing flow and/or a new flow to said router. When the resource detects that a flow of weight w is starting, the internal feedback variable μ may be set to be equal to μ^{new} for some value μ^{new} which is a function of μ, w and the aggregate flow statistics maintained at the resource. The value of μ^{new} should be chosen so that the change in feedback provokes a reaction in the underlying congestion control process which results in a reduction in aggregate flow through the resource, approximately sufficient to accommodate a new flow of weight w. One way to calculate an appropriate μ^{new} is to set μ^{new}=μ+Δμ, where Δμ is chosen so that

$$Δμ \frac{\partial y}{\partial μ}$$

is approximately equal to the expected amount of bandwidth required to accommodate a new flow of weight w. As before, ∂y/∂μ represents the responsiveness of the aggregate flow y to changes in the internal feedback variable μ, according to the underlying congestion control scheme. The same techniques as used for calculating Δμ as in the unweighted case are still applicable. Furthermore, there is also the possibility of including flow weights in the weighting of the averages begin taken.

For example, for α Fair RCP with α=1 and weighted flows, an appropriate change in Rⱼ is:

$${R}_{j}^{new} = {R}_{j} \frac{{y}_{j}}{{y}_{j} + {wR}_{j}}$$

When the resource detects an increase in the weight by w for an existing flow, the resource may also react similarly as to when a new flow of weight w begins. This allows the possibility of connection initialisation being implemented in a series of stages.

The new data flow may goes through successive increases in weight up to full strength, with the resource altering the internal feedback variable μ to allow spare bandwidth for each increase in flow weight. This may allow a new flow with a large weight to initialise slowly. For example, a flow with eventual weight w may go through a series of stages, starting off with weight w/n and increasing the weight, every round trip time, for example, until it reaches w. Alternatively, flows may start with weight 1, increase by 1 unit every round-trip time until a desired weight is reached. The final increase may have a value between 0 and 1.

Let us consider, a simple illustrative example. Consider two competing users, named A and B, who each wish to use the same communication link for different activities. Say, user A wishes to use a Web phone service and user B wishes to play a networked game. If the capacity on the link is not large enough to support both the activities, congestion will result and performance can degrade. Today, communication networks generally lack a mechanism whereby users may be able to express their priority for use of network resources. When a resource gets congested, a means of differentiating among users would be helpful. The above-described process may help in facilitating this differentiation.

A similar process may also be beneficial where flows do not have weights. Initially a new flow may go through one or more stages where it was treated as a less important flow and given less bandwidth. Eventually the bandwidth allocated to a new flow may increase so that the new flow is treated as equally important as other flows under whatever fairness regime is in operation. This may help reduce the impact of the addition of new sources to the network.

According to another aspect of the invention, there is provided a method of connecting a new source to a communication network comprising at least one source connected to at least one destination via a plurality of routers with a plurality of data flows from said at least one source to said at least one destination, said method comprising storing local information relating to each said router at each said router; determining, using said stored local information, an internal feedback variable indicative of congestion at each said router; detecting a new data flow on the network; determining, using said stored local information and said internal feedback variable, an adjustment to said internal feedback variable at each router to accommodate said new flow; and communicating data representing said adjusted internal feedback variable to said source of said new flow and to sources of existing data flows, whereby said sources of existing data flows adjust their flow rates so that there is a reduction in the aggregate flow rate of sources of existing data flows to accommodate said new flow

According to another aspect of the invention, there is provided a method of resource management comprising: maintaining an estimate of aggregate flow rate through the resource; detecting the start of a new flow; calculating an estimate of the requisite reduction factor, required for the aggregate flow, in order to accommodate a new flow and modifying the resources internal feedback variable so that the aggregate flow rate is reduced by the requisite reduction factor.

According to another aspect of the invention, there is provided a method of resource management for weighted flows comprising: maintaining an estimate of aggregate flow rate through the resource; detecting the start of a new flow and determining the starting weight, say w calculating an estimate of the requisite reduction factor, required for the aggregate flow, in order to accommodate the new demand, which can be expressed in the form of a weight, w modifying the resources internal feedback variable so that the aggregate flow rate is reduced by the requisite reduction factor taking the new demand, which can be expressed in the form of a weight w , into consideration.

According to another aspect of the invention, there is provided a method of connection initialisation over networks with weighted fair congestion control comprising: resources operating a weighted resource management method and resources reacting to each increase in flow weight as if it were a new connection.

The invention further provides processor control code to implement the above-described methods, for example on a general purpose computer system or on a digital signal processor (DSP). The code may be provided on a carrier such as a disk, CD- or DVD-ROM, programmed memory such as read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

All of the above aspects relate to methods and processes of congestion control which may be designed to be compatible with a wide variety of buffer sizing regimes. By using the methods and processes described above, in particular a control process for the admission of new flows into the network and a method to enable users to have additional weighting, it is possible to design a network with routers having small buffer, say even to the order of 20-100 packets, or even 30 packets.

According to a further aspect the invention provides a router having at least first and second communication ports to receive and send out data packets, queue memory coupled to buffer incoming data packets from at least one of said communication ports, and a controller configured to read information in said incoming data packets and to send out routed said data packets responsive to said read information, and wherein said controller is further configured to control a rate of said sending out of said data packets based on local information available to said router and without relying on packet loss information received by said router from another router; and wherein said control of said rate of said sending out of said data packets from the router is at least in part performed by controlling a rate of reception of said data packets at said router by communicating rate control data to one or more sources of said data packets to control a rate at which said data packets are sent from said one or more sources to said router; and wherein said local information comprises one or more of an aggregated volume of packet data traffic into said router, a data packet queue length in said router, and information defining that a new connection to said router has commenced

The inventors describe elsewhere in this specification some preferred mathematical procedures to enable such a local routing algorithm to be employed substantially without feedback amongst the routers within a network causing instability: the techniques we describe facilitate a change at one router propagating through and equilibriating within a network of the routers.

These techniques facilitate the use of a very short queue within the router, for example less than 1000, potentially of order or less than 100 data packets. This may be contrasted within a conventional router in which the queue is typically of length 100K to 1,000,000 packets. In preferred embodiments the router has a speed of greater than 10 Gbps. Thus even with a short queue the router may have, in embodiments, a bandwidth-delay product (the delay being defined, for example) by an average round trip time for all the flows using the router) of greater that 25K, 100K, or 500K.

Some preferred implementations of the router employ a stochastic packet flow, that is defining an average rate of transmission of data packets, preferably approximating a Poisson distribution; this helps to avoid synchronicity in a network comprising multiple connected routers of the type described. This in turn also facilitates scalability of a network comprising the router.

Preferred embodiments of the router also include a system for allocating (increasing) data packet flow capacity or throughput for the user. Preferably where a user has a requirement for a substantial increase in capacity then, rather than the capacity being delivered immediately, the router incrementally, in a stepwise fashion, adds capacity for the user until the desired target capacity is met. Thus, for example, an incremental step of additional capacity may be substantially the same as that allocated to a new user joining a network and employing the router. The time steps in increasing the capacity to a user may be defined, for example, by a packet round trip time.

Such an approach enables a network of the routers to adapt to the changing capacity, again using in embodiments only a local rule, giving time for the network to equilibriate at each step.

The above-described techniques can be applied with TCP (Transmission Control Protocol) data packets and thus, for example, the firmware of an existing router can be updated to operate according to a procedure as described herein to provide substantially improved performance.

According to another aspect of the invention, there is provided a method of adding a new user to a packet data network, the data network including a plurality of existing users coupled by routers, the method comprising allocating packet data capacity for said new user at a said router by performing at said router a control method comprising:
determining an internal feedback variable in said router, said internal feedback variable indicating a degree of congestion at said router;
maintaining, in said router, local traffic data relating to traffic through said router, said local traffic data being dependent on one or more of an aggregate data packet flow through said router and an average data packet queue length in said router;
identifying at said router a packet flow of said new user;
changing said internal feedback variable by a step change responsive to said identification of said packet flow of said new user; and
including data representing said internal feedback variable in data packets of both said existing users and said new user sent from said router into said network;
wherein said new user and existing users acting as sources of said data packets are responsive to said data representing said internal feedback variable to control a rate of sending data packets such that packet data flows through said routers of said network tend towards an equilibrium

A said new or existing user may receive said data representing said internal feedback variable in an acknowledgement data packet sent back from a destination of a said data packet sent by said new or existing users. A magnitude of said step change may be dependent on one or more of said aggregate data packet flow rate, said queue length, and a capacity of the router changing said internal feedback variable. Alternatively, a magnitude of said step change may be substantially equal to a value which provides proportional fairness for said equilibrium.

### BRIEF DESCRIPTION OF DRAWINGS

FIGS. 1a, 1b and 1c show a network at three discrete times;

FIG. 2 is a graph showing the evolution of queue size over time (t) for a single-round trip time;

FIG. 3 is an empirical distribution of queue size within one round-trip time;

FIG. 4a is a graph showing the variation of utilisation ρ for different values of the parameter b, measured over one round-trip time with 100 RCP sources sending either Poisson or periodic traffic;

FIG. 4b is a graph showing the variation of utilisation ρ for different values of the parameter b, measured over one round-trip time with 100 RCP sources sending Poisson traffic;

FIG. 4c is a graph showing the variation of utilisation ρ for different values of the parameter γ, measured over one round-trip time with 100 RCP sources sending Poisson traffic;

FIGS. 5a and 5b show the variation in queue size with time for a packet-level simulation of a single bottleneck line with 100 RCP sources having a round-trip time of 100 units, a target link utilization of 90%, with and without feedback, respectively;

FIGS. 6a and 6c show the variation in rate with time for a packet-level simulation of a single bottleneck line with 100 RCP sources having a round-trip time of 1000 units which is in equilibrium and experiences a 20% increase in load, with and without feedback, respectively;

FIGS. 6b and 6d show the variation in queue size with time for a packet-level simulation of a single bottleneck line with 100 RCP sources having a round-trip time of 1000 units which is in equilibrium and experiences a 20% increase in load, with and without feedback, respectively;

FIG. 7 is a schematic illustration of a toy network used to illustrate the process of admitting new flows into a RCP network;

FIGS. 8a and 8b show the variation in rate and queue size with time for link C of FIG. 7 when a 50% increase in flows request admittance to the network;

FIGS. 8c and 8d show the variation in rate and queue size with time for link X of FIG. 7 when a 50% increase in flows request admittance to the network;

FIGS. 9a and 9b show the variation in rate and queue size with time for link C of FIG. 7 when a 100% increase in flows request admittance to the network; and

FIGS. 9c and 9d show the variation in rate and queue size with time for link X of FIG. 7 when a 100% increase in flows request admittance to the network.

### DETAILED DESCRIPTION OF DRAWINGS

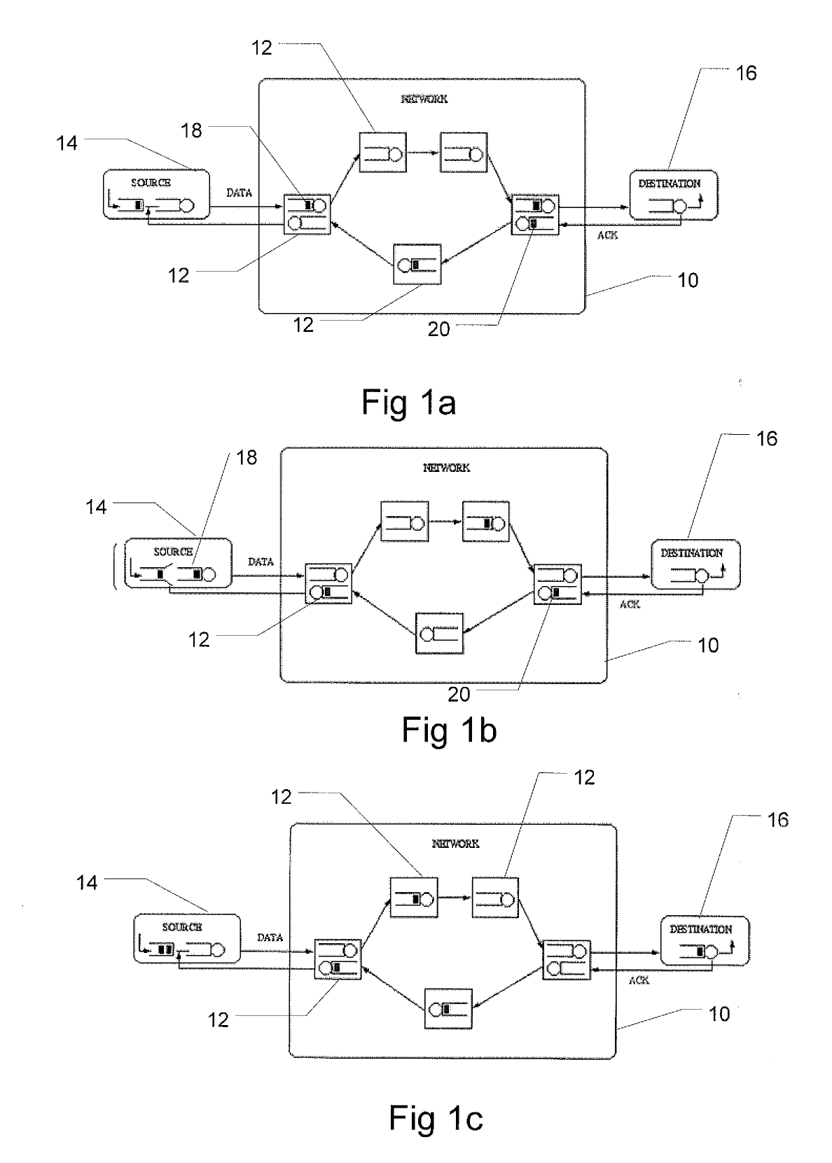

FIGS. 1a, 1b and 1c show a network 10 with a set J of resources or routers 12. The network 10 connects a source 14 to a destination 16. A route r will be identified with a non-empty subset of J, and jεr indicates that route r passes through resource j. In FIGS. 1a to 1c, the route passing data 18 from source 14 to the destination 16 passes through four resources. There is also a return route transmitting an acknowledgement 20 from the destination to the source which passes through three resources, two of which are common to the data route. FIGS. 1a to 1c shows the progress of data and acknowledgement over the network at three discrete times. There may be other possible routes and R is the set of possible routes. Models defining congestion on the network have been described above. Another version of the revised RCP model is defined by the following set of equations:

$$\frac{d}{d t} {R}_{j} ( t ) = \frac{{aR}_{j} ( t )}{{C}_{j} {\overline{T}}_{j} ( t )} ( {C}_{j} - {y}_{j} ( t ) - {b}_{j} {C}_{j} {p}_{j} ( {y}_{j} ( t ) ) )$$

$$where$$

$${y}_{j} ( t ) = {\sum }_{r : j ∈ r} {x}_{r} ( t - {T}_{rj} )$$

is the aggregate load at link j, pⱼ(yⱼ) is the mean queue size at link j when the load there is yⱼ and

$${\overline{T}}_{j} ( t ) = \frac{{\sum }_{r \text{:} j ∈ r} {x}_{r} ( t ) {T}_{r}}{{\sum }_{r \text{:} j ∈ r} {x}_{r} ( t )}$$

is the average round-trip time of packets passing through resource j.

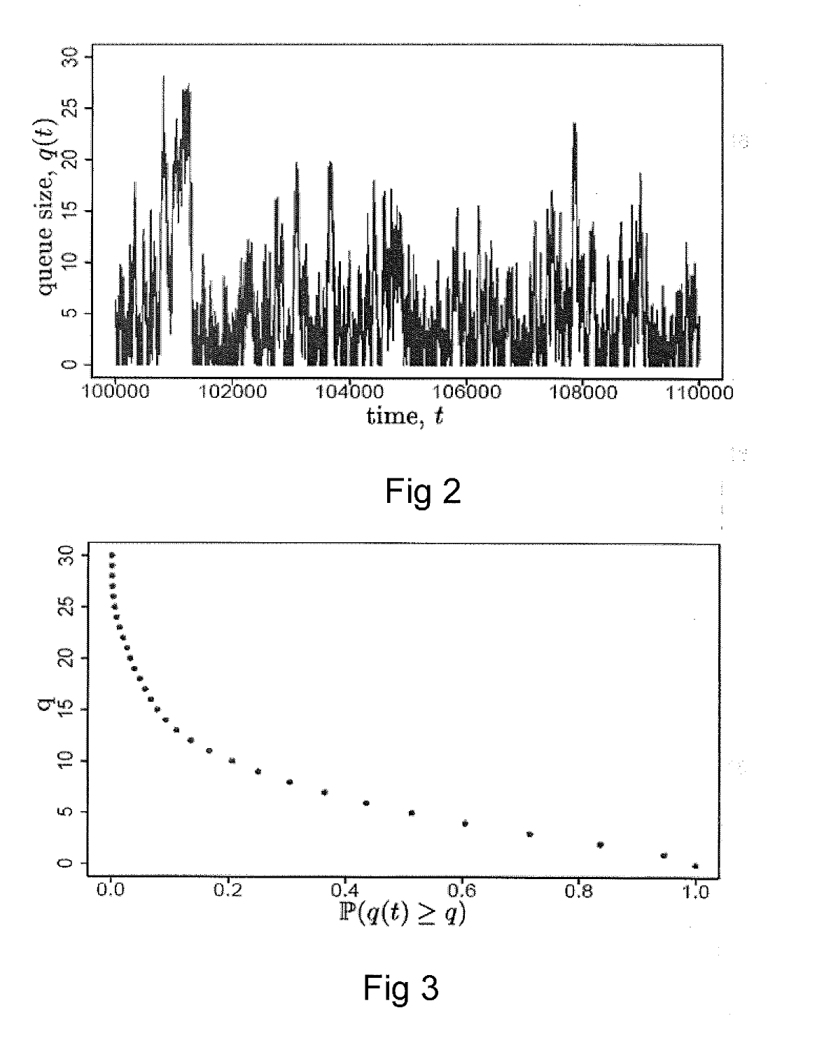

The parameters in common have the same notation as other RCP models. The key difference is that the variation of the RCP protocol above acts to control the distribution of queue size. With small buffers and large rates the queue size fluctuations are very fast, e.g. as shown in FIG. 2. On the time-scale relevant for convergence of the system, it is then the mean queue size that is important. This produces a simplification of the key relation, namely the instantaneous queue size q(t) can be replaced by its mean. This simplification of the treatment of the queue size allows us to obtain a model that remains tractable even for a general network topology.

We suppose the flow rate xᵣ is given by

$${x}_{r} ( t ) = {( {\sum }_{j ∈ r} {{R}_{j} ( t - {T}_{jr} )}^{- α} )}^{- 1 / α} .$$

Observe that, as α→∞, the above expression approaches min_{jεr}(Rⱼ(t−Tⱼᵣ)), corresponding to max-min fairness. In general, the flows at equilibrium will be weighted α-fair with weights wᵣ

Note that for bounded values of a the above computation can be performed as follows. If a packet is served by link j at time t, Rⱼ(t) ^{α} is added to the field in the packet containing the indication of congestion. When an acknowledgement is returned to its source, the acknowledgement reports the sum, and the source sets its flow rate equal to the returning feedback to the power of −1/α.

A simple approximation for the mean queue size is as follows. Suppose that the workload arriving at resource j over a time period τ is Gaussian, with mean yⱼτ and variance yⱼτσⱼ². Then the workload present at the queue is a reflected Brownian motion (see J M Harrison. Brownian Motion and Stochastic Flow Systems. Krieger 1985), with mean under its stationary distribution of

$${p}_{j} ( {y}_{j} ) = \frac{{y}_{j} {σ}_{j}^{2}}{2 ( {C}_{j} - {y}_{j} )} .$$

The parameter σⱼ² the variability of link j's traffic at a packet level. Its units depend on how the queue size is measured: for example, packets if packets are of constant size, or Kilobits otherwise.

At the equilibrium point y=(yⱼ, jεJ) for the dynamical system defined by the revised RCP algorithm we have

Cⱼ−yⱼ=bⱼCⱼpⱼ(yⱼ).

From the previous two equations it follows that at the equilibrium point

$${p}_{j}^{′} ( {y}_{j} ) = \frac{1}{{b}_{j} {y}_{j}} .$$

it is possible to show that the dynamical system is locally stable about its equilibrium point if

$$a < \frac{π}{4} .$$

it is noteworthy that this simple decentralized sufficient condition places no restriction on the parameters bⱼ, jεJ , provided the modeling assumption of small buffers is satisfied.

The parameter α is the same as in the original known model of RCP. However, another difference is that the parameter bⱼ is a rescaled version of β,

$${b}_{j} = \frac{β}{{aC}_{j} {\overline{T}}_{j}} ,$$

and its units are the reciprocal of the units in which the queue size is measured.

The parameter α controls the speed of convergence at each resource, while the parameter bⱼ controls the utilization of resource j at the equilibrium point. From the equations for p(_{j,yj}) and the equilibrium point above, we can deduce that the utilization of resource j is

$${ρ}_{j} ≡ \frac{{y}_{j}}{{C}_{j}} = 1 - {{σ}_{j} ( \frac{{b}_{j}}{2} \cdot \frac{{y}_{j}}{{C}_{j}} )}^{1 / 2}$$

and hence that

$$\begin{matrix}{ρ}_{j} = {( {( 1 + \frac{{σ}_{j}^{2} {b}_{j}}{8} )}^{1 / 2} - {( \frac{{σ}_{j}^{2} {b}_{j}}{8} )}^{1 / 2} )}^{2} \\ = 1 - {{σ}_{j} ( \frac{{b}_{j}}{2} )}^{1 / 2} + O ( {σ}_{j}^{2} {b}_{j} ) .\end{matrix}$$

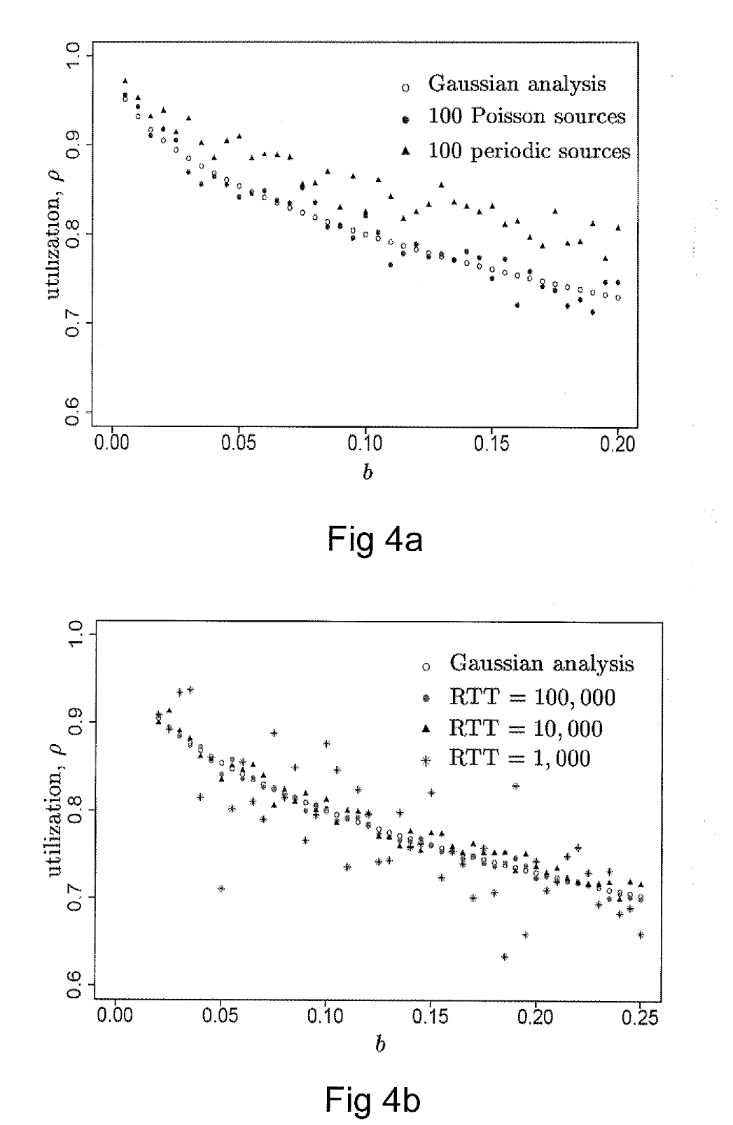

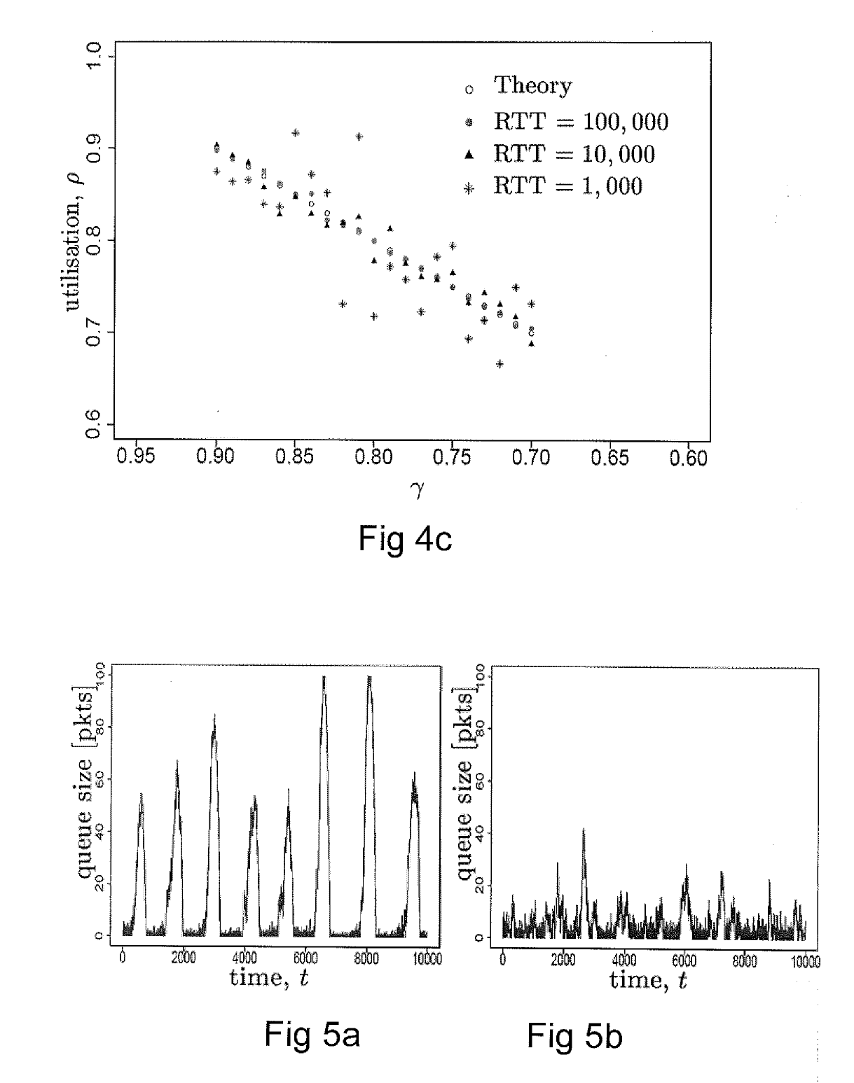

For example, if σⱼ=1, corresponding to Poisson arrivals of packets of constant size, then a value of bⱼ=0.022 produces a utilization of 90%. FIG. 4a plots the function ρⱼ, under the label ‘Gaussian analysis’ and shows how utilization decreases as bⱼ increases.

It is important to note that setting the parameter bⱼ to control utilization produces a very different scaling for β from that used in an earlier publication (Balakrishnan et al.,“Stability analysis of explicit congestion control protocols” volume 11, number 10, pp. 823-825, IEEE Communications Letters, 2007), as a consequence of the presence of the bandwidth-delay product Cⱼ T̅ⱼ in the primary relation for the revised RCP. In particular, if the bandwidth-delay product Cⱼ T̅ⱼ is large, the values considered for β are much larger than those considered in this earlier publication.

If the parameters bⱼ are all set to zero, and the algorithm uses as Cⱼ not the actual capacity of resource j , but instead a target, or virtual, capacity of say 90% of the actual capacity, this too will achieve an equilibrium utilization of 90%. In this case, it may be demonstrated (e.g. by adapting the work of Vinnicombe “on the stability of networks operating TCP-like congestion control” Proceedings of IFAC World Congress, Barcelona 2002; F Kelly “Fairness and stability of end-to-end congestion” European Journal of Control, 9:159-176, 2003; and/or T Voice “Stability of multi-path dual congestion control algorithms” IEEE/ACM Transactions on Networking, 15:1231-1239, 2007) the equivalent sufficient condition for local stability is

$$a < \frac{π}{2}$$

Although the presence of a queuing term is associated with a smaller choice for the

$$a < \frac{π}{4} .$$

parameter α—note the factor two difference between the sufficiency conditions

$$a < \frac{π}{2}$$

and defined above—nevertheless, close to the equilibrium the local responsiveness is comparable, since the queuing term contributes roughly the same feedback as the term measuring rate mismatch. Below equilibrium, the b=0 case is more responsive (up to a factor of 2); above equilibrium, the b>0 case is more responsive (how much more responsive depends on the buffer size).

In the taxonomy used in F Kelly “Fairness and stability of end-to-end congestion” European Journal of Control, 9:159-176, 2003, we are considering fair dual algorithms rather than delay-based dual algorithms (see Low et al “Optimisation flow control” IEEE/ACM Transactions on Networking, 7:861-874, 1999 and Paganin et al “Congestion control for high performance, stability and fairness in general networks, IEEE/ACM Transactions on Networking, 13:43-56, 2005). This is important for the form of the sufficiency conditions for a set out above.

FIGS. 2 to 6 illustrate key features of the small buffer variant of the RCP algorithm described above with a simple packet level simulation. The network simulated has a single resource, of capacity one packet per unit time, and 100 sources that each produce Poisson traffic. At the resource the buffer size was 200 packets, and no packets were lost in the simulations. The buffer size would be important for behaviour away from equilibrium. The round-trip time is 10000 units of time. Assuming a packet size of 1000 bytes, this would translate into a service rate of 100 Mbytes/s, and a round-trip time of 100 ms, or a service rate of 1 Gbyte/s and a round-trip time of 10 ms. The RCP parameters take the values α=0.5 and β=100. Thus b=β/(αCT) =0.02 packets.

FIGS. 2 to 6 are generated using a discrete event simulator of packet flows in RCP networks. The links are modeled as FIFO queues, with internal feedback variables which evolve according to a discrete approximation of the main equation expressing the standard RCP algorithm. The sources are modeled either as N time-varying Poisson sources or N periodic sources.

The link has an internal variable, R(t), the fair rate through the link for a flow unconstrained elsewhere. If a packet arrives or leaves a link at time t, and the previous time such an event occurred was t−δt, then R(t) updates according to

$$log ( R ( t ) ) = log ( R ( t - δ t ) ) + \frac{1}{CT} ( a ( C δ t - I ( t - δ t , t ) ) - β \frac{q ( t - )}{T} δ t )$$

where α, β are positive constants, C is the capacity of the link, T is the common round-trip time, q(t−) is the queue size immediately before the event at time t and I(t−δt,t) is the number of packet arrivals in the interval [t−δt,t). The queue size is not necessarily integral—a partially served packet contributes only its remaining service time; q(t−), so defined, is often termed the virtual waiting time (see J. W. Roberts (ed.) (1992). Performance Evaluation and Design of Multiservice Networks. Office for Official Publications of the European Communities, Luxembourg).

This is our discrete approximation to the main equation expressing the standard RCP algorithm. The discrete approximation also reduces to equation expressing the revised RCP algorithm if we identify p(y) with the mean value of q(t), and relate b and β as previously indicated.

If a packet is served by a link at time t, R(t)^{-α} is added to that packet's congestion feedback variable. When an acknowledgement is returned to its source, the source sets its flow rate equal to the returning feedback to the power of −1/α. When the RCP sources are Poisson, the remaining time until next packet transmission is simply recalculated as an exponential random variable with parameter equal to the new flow rate. For a network with a single resource, this corresponds to each source sending a Poisson stream at the latest rate R(t) to be received from the link. When an RCP source is periodic, it sends a stream of packets with period R(t)⁻¹.

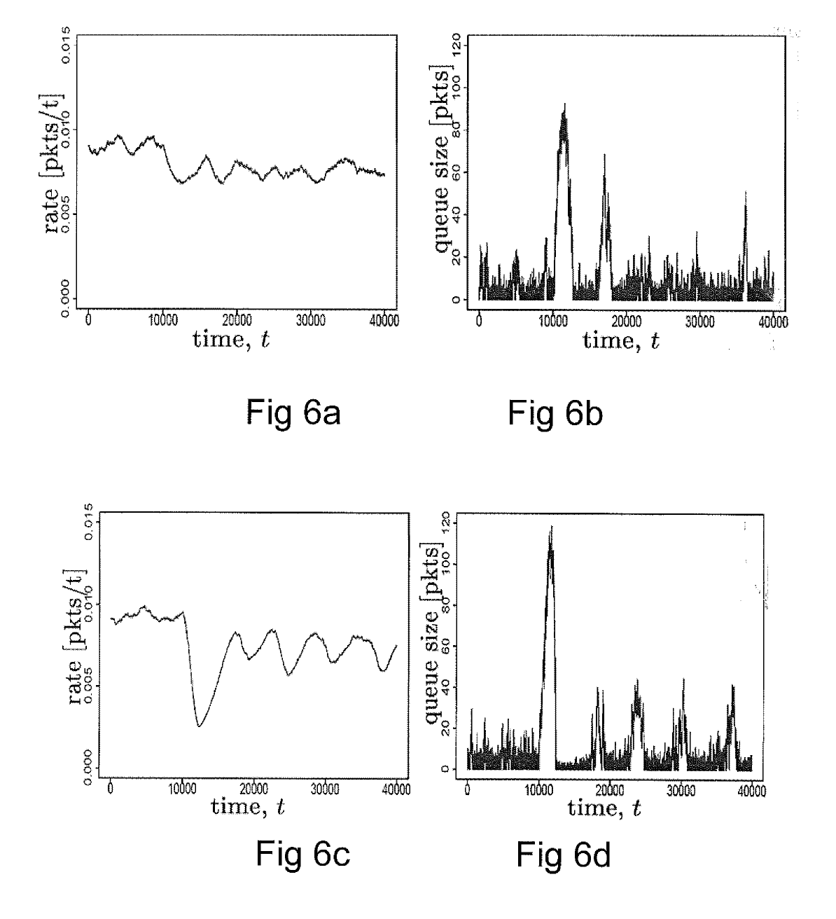

The observations plotted in FIGS. 2 to 4c were obtained over one round-trip time, after the simulation had been running for ten round-trip times starting from near equilibrium. The traces plotted in FIGS. 5a to 6d were for a network with a single resource.

FIG. 2 shows the evolution of the queue size in one round-trip time. Note that the queue size fluctuates rapidly within a round-trip time, frequently reflecting from zero. FIG. 3 shows the empirical distribution of the queue size over the same single round-trip time; it is calculated from the sample path shown in FIG. 2.

As set out above, FIG. 4a plots the function ρ obtained from our earlier analysis with a σ=1, labeled ‘Gaussian analysis’. The utilization observed in the simulations for the case where 100 sources each send Poisson traffic is also plotted under the label ‘100 Poisson sources’. Two features of the simulated results are notable. First, the variability of the utilization, measured over one round-trip time. This is to be expected, since there remains variability in the empirical distribution of queue size, FIG. 3. This source of variability decreases as the bandwidth-delay product CT increases. Second, apart from this variability, the utilization is rather well represented by function ρ obtained from our earlier analysis. Further simulations, not described here, show the match become closer and closer as the bandwidth-delay product CT increases.

The differential equations above describe the system behaviour at the macroscopic level, where flows are described by rates. At the packet, or microscopic level, there is choice on how the sources may regulate their flow, in response to the feedback that they get from the network. Sources that send approximately Poisson traffic might be expected to lend themselves especially well to our approach, since the superposition of independent Poisson streams is a Poisson stream, and the number of streams superimposed does not affect the statistical characteristics of the superposition other than through the rate, which is modeled explicitly. Furthermore, for a constant rate Poisson arrival stream of constant size packets, i.e. an M/D/1 queue, the exact mean queue size is known, and indeed matches the relation for function ρ obtained from our earlier analysis with a σ=1 (see Mo et al. “Fair end-to-end window-based congestion control” IEEE/ACM Transactions on Networking, 8:556-567, 2000). Thus the rather good match between the utilization and the relation for function ρ is to be expected for Poisson sources.

Next an example where each source sends a near periodic stream of traffic is illustrated. The period is the inverse of the source's rate. FIG. 4a plots the utilization observed in the simulations under the label ‘100 periodic sources’. The simulated data show variability, as expected, but now lie above the Gaussian analysis. Again an exact analysis of a special case is able to provide insight. A superposition of periodic streams produces queuing behaviour which has been studied extensively (see B. Hajek. A queue with periodic arrivals and constant service rate. In F. P. Kelly (ed.) Probability, Statistics and Optimisation: a Tribute to Peter Whittle. Wiley, Chichester. 1994, 147-157 or J. W. Roberts (ed.) (1992). Performance Evaluation and Design of Multiservice Networks. Office for Official Publications of the European Communities, Luxembourg). The ND/D/1 queue, as it is termed, locks into a repeating pattern of busy periods. Over time intervals small in comparison with the period of a source, the queuing behaviour induced is comparable with that induced by a Poisson stream. But over longer periods the arrival pattern has less variability than a Poisson stream. This will lead to a lower expected queue size and hence a higher utilization for any given value of b.

Periodic sources through a single congested resource have been simulated since this seems likely to be an extreme case.

FIGS. 3 and 4 show the comparison between theory and the simulation results, when the round-trip times are in the range of 1,000 to 100,000 units of time. FIG. 3 represents the case where the queue term was present in the RCP definition. In FIG. 4 where the queue term is absent, we replace C with γC for γε [0.7, . . . , 0.90] in the protocol definition.

We first note that when the round-trip time is in the region of 100,000 there is excellent agreement between theory and simulations in both FIGS. 3 and 4. So, in this regime, based on local stability analysis we are unable to distinguish between the two different design choices. This provides motivation for analysis which goes beyond local stability. The reader is referred to T. Voice and G. Raina. (2007). Rate Control Protocol (RCP): global stability and local Hopf bifurcation analysis. Preprint which analyses some non-linear properties of the RCP dynamical system, with and without the queue term, in a single resource setting where the conclusions tend to favour a system where the queue term is absent.

FIGS. 4b and 4c show a similar simulation to that of FIG. 4a, i.e. a network having a single resource of capacity one packet per unit time. There are a 100 sources each producing Poisson traffic with round-trip times in the range of 100 to 100,000. As detailed above, by removing the feedback based on queue size, the value of the parameter α can be double in the sufficient condition for local stability. Accordingly, when feedback based on queue size is included, α=0.5. When the queue feedback is excluded, i.e. b=0, a is set as 1 and C is replaced with γC for some γ<1. The simulations are started close to equilibrium.

As shown in FIGS. 4b and 4c, as one reduces the round-trip time from 100,000 to 1,000 time units, greater variability in utilization is observed. If one reduces the round-trip time further, say down to 100 time units, queuing delays can start to become comparable to physical transmission delays. In such a regime our small buffer assumption—that queuing delays are negligible in comparison to propagation delays—breaks down. This is a regime where, in control theoretic parlance, the queue is acting as an integrator on approximately the same time scale as the round-trip time of a congestion control algorithm. Models aiming to capture this regime have been analysed previously in the literature (for example, for RCP see H. Balakrishnan, N. Dukkipati, N. McKeown and C. Tomlin Stability analysis of explicit congestion control protocols. IEEE Communications Letters, vol. 11, no. 10, 2007 and for TCP see C. V. Hollot, V. Misra, D. Towsley and W. Gong. Analysis and design of controllers for AQM routers supporting TCP flows. IEEE/ACM Transactions on Automatic Control, 47(6):945-959, 2002. or G. Raina and D. Wischik. Buffer sizes for large multiplexers: TCP queuing theory and instability analysis. Proc. EuroNGI Next Generation Internet Networks, Rome, Italy, April 2005. All these publications employ different styles of analysis from each other.

We resort to simulations to develop our understanding of this regime with our variant of RCP. To achieve 90% utilization in our small buffer model we need to set b=0.02. Now recall the relationship between b, the small buffer rescaled parameter, and the original RCP model parameter β. So α=0.5, C=1, T=100 and b=0.02 yields β=1. Stability charts in H. Balakrishnan, N. Dukkipati, N. McKeown and C. Tomlin. Stability analysis of explicit congestion control protocols. IEEE Communications Letters, vol. 11, no. 10, 2007 suggest that the choice β=1 and α=0.5 lies outside their provably safe stability region for a large range of round-trip times. And indeed we observed deterministic instabilities in our simulations: see FIG. 5(a).

To aim for a fixed utilization we can also set b =0 and target a virtual capacity; say 90% of the actual capacity. Without the queue term in the RCP definition, the congestion controller is reacting only to rate mismatch and with a round-trip time of 100 time units, we did not observe any deterministic instabilities: see FIG. 5(b). In this regime, the presence of the queue term in the definition of the RCP protocol causes the queue to be less accurately controlled.

All the previous experiments were conducted in a static scenario: fixed number of long-lived flows, sending traffic, in equilibrium. We now motivate a more dynamic setting. Consider a link, targeting 90% utilization with 100 flows and a round-trip time of 1000 time units, which suddenly has a 20% increase in load. As motivation, consider the failure of a parallel link with similar characteristics where 20% of the load is instantaneously transferred to the link under consideration.

We explore this scenario via a simulation. For this experiment, see FIGS. 6a to 6d for the evolution of the queue and the rate for the cases with and without feedback based on queue size. The scenario when the queue size is included in the feedback is less appealing: the queue appears to have periodic spikes, and the rate seems to remain in a quasi-periodic state, even after 30 round-trip times.

FIGS. 4b to 6d lead to the conclusion that, for the small buffer variant of RCP, there is no clear case that feedback based on queue size is helpful and some evidence that it is harmful. Accordingly, the simplified version of the revised variant of RCP termed α Fair RCP above may be used where b=0. Alternatively, the closely related fair-dual algorithm described above may be used.

A key outstanding question is how new flows may reach equilibrium. In our example models, when a new flow starts, it learns, after one round-trip time, of its starting rate. Outlined below is a step-change algorithm which addresses the issue of how a resource could react when it learns of a new flow about to start.

For now we consider the case where α=1. For the rate control protocol model, the flow rate is set to

$${x}_{r} ( t ) = {{w}_{r} ( {\sum }_{j ∈ r} {{R}_{j} ( t - {T}_{jr} )}^{- 1} )}^{- 1}$$

which will produce weighted proportional fairness at equilibrium, with weight wᵣ for flow r. For the fair dual algorithm model, if we define Rⱼ(t)=μⱼ(t)⁻¹ for each resource j then the above equation still applies.

We first outline the step-change algorithm for the case where flows are unweighted, i.e. wᵣ=1 for all r, and then consider the case for flows with general weights.

In equilibrium, the aggregate flow through resource j is yⱼ, which is equal to Cⱼ by the equilibrium structure of our systems. When a new flow, r, begins transmitting, if jεr, this will disrupt the equilibrium by increasing yⱼ to yⱼ+xᵣ. Thus, in order to maintain equilibrium, whenever a flow, r, begins Rⱼ needs to be decreased, for all j with jεr.

According to both equations defining yⱼ(t) above:

$${y}_{j} = {\sum }_{r \text{:} j ∈ r} {{w}_{r} ( {\sum }_{k ∈ r} {R}_{k}^{- 1} )}^{- 1}$$

and so the sensitivity of yⱼ to changes in the rate Rⱼ is readily deduced to be

$$\frac{\partial {y}_{j}}{\partial {R}_{j}} = \frac{{y}_{j} {\overline{x}}_{j}}{{R}_{j}^{2}}$$

$$where$$

$${\overline{x}}_{j} = \frac{{\sum }_{r \text{:} j ∈ r} {{x}_{r} ( {\sum }_{k ∈ r} {R}_{k}^{- 1} )}^{- 1}}{{\sum }_{r \text{:} j ∈ r} {x}_{r}} .$$

This x̅ⱼ, is the average, over all packets passing through resource j, of the unweighted fair share on the route of a packet.

Suppose now that when a new flow begins, it sends a request packet through each resource j on its route, and suppose each resource j, on observation of this packet, immediately makes a step-change in Rⱼ to a new value

$${R}_{j}^{new} = {R}_{j} \cdot \frac{{y}_{j}}{{y}_{j} + {R}_{j}} .$$

In the case of the fair dual algorithm model, the step-change would be in μⱼ, to the new value, μⱼ^{new}=(Rⱼ^{new})⁻¹. The purpose of the reduction is to make room at the resource for the new flow. Although a step-change in Rⱼ will take time to work through the network, the scale of the change anticipated in traffic from existing flows can be estimated from the equations for x̅ⱼ and

$$\frac{\partial {y}_{j}}{\partial {R}_{j}}$$

as

$$( {R}_{j} - {R}_{j}^{new} ) \cdot \frac{\partial {y}_{j}}{\partial {R}_{j}} = {\overline{x}}_{j} \cdot \frac{{y}_{j}}{{y}_{j} + {R}_{j}} .$$

Thus the reduction aimed for from existing flows is of the right scale to allow one extra flow at the average of the unweighted fair share through resource j. Note that this is achieved without knowledge at the resource of the individual flow rates through it, (xᵣ, r: jεrr): only knowledge of their equilibrium aggregate yⱼ is used in expression Rⱼ^{new}.

In the situation where flows have different weights, care must be taken before admitting such users into the network. When a new flow, r, of weight wᵣ requests to enter the network, it could advertise wᵣ to resources jεr. On receiving this request, the resource j immediately makes a step-change in Rⱼ to a new value

$${R}_{j}^{new} = {R}_{j} \frac{{y}_{j}}{{y}_{j} + {w}_{r} {R}_{j}}$$

Again for example for the fair dual algorithm model, j would change μⱼ, to the new value, μⱼ^{new}=(Rⱼ^{new})⁻¹. The scale of the change anticipated in traffic om existing flows can be estimated from the equations for

$$\frac{\partial {y}_{j}}{\partial {R}_{j}}$$

### and Rⱼ^{new} as

$$( {R}_{j} - {R}_{j}^{new} ) \cdot \frac{\partial {y}_{j}}{\partial {R}_{j}} = {w}_{r} {\overline{x}}_{j} \frac{{y}_{j}}{{y}_{j} + {w}_{r} {R}_{j}}$$

Thus the reduction aimed for from existing flows is of the right scale to allow one extra flow at the average of the wᵣ weighted fair share through resource j.

Alternatively, the new flow could be initialised through a sequence of increments in wᵣ. Each increment is then advertised to resources and reacted to by them as though it were the request of a new flow with weight equal to that increase in wᵣ, according to the last equation Rⱼ^{new}. For example, for flows with integer values, a new flow could be initialised as a series of increases in wᵣ at a rate of 1 per round-trip time.

The above discussion is centred around the case where α is equal to 1. A generalisation of the step-change process described above to the case of general α would be for a resource j to update Rⱼ (t) to

$${R}_{j}^{new} = {R}_{j} \frac{{y}_{j}}{{y}_{j} + {w}_{r} {R}_{j}}$$

on receiving a request for a new flow r of weight wᵣ or an increase of wᵣ in weight for an existing flow, r. Note that in this generalization, the Rⱼ^{new} is the same as outlined above.

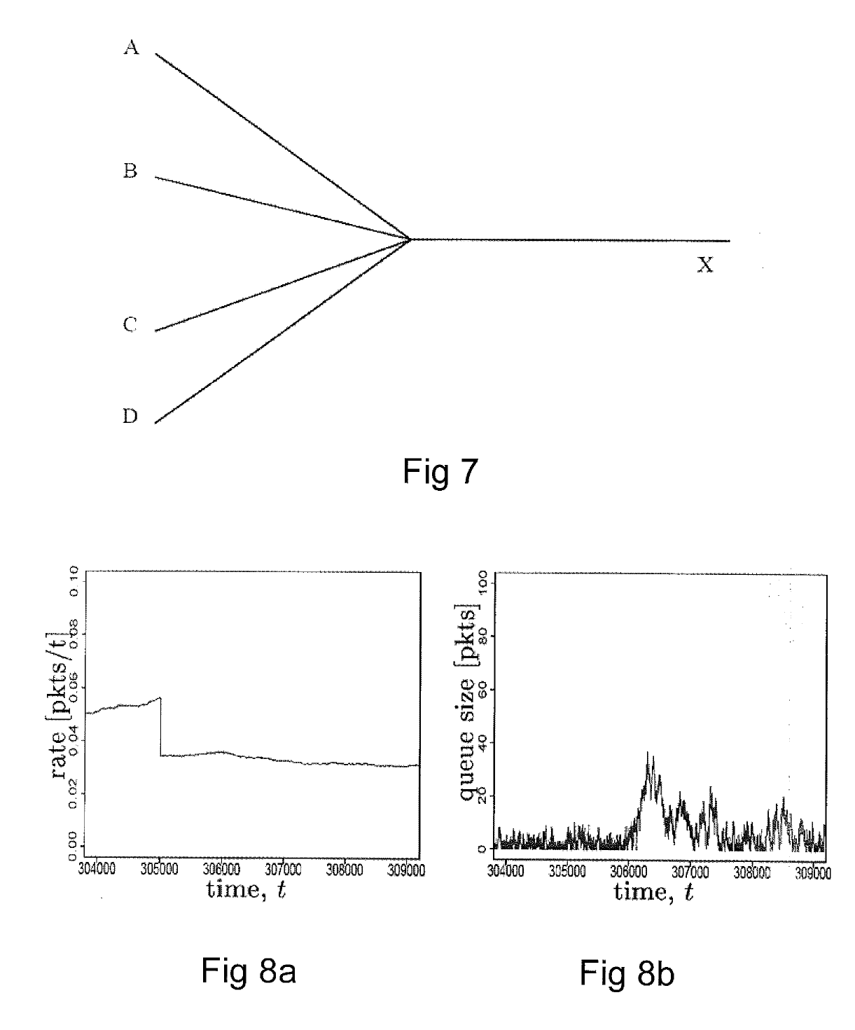

FIG. 7 shows a toy network consisting of five links labelled A, B, C, D and X where the links have a capacity of 1, 10, 1, 10 and 20 packets per unit time, respectively. The physical transmission delays on links A, B and X are 100 time units and on links C and D are 1000 time units. No feedback based on queue size is included in the RCP definition. The target utilisation for each link is 90%. In the experimental set-up, links A, B, C and D each start with 20 flows operating in equilibrium. Each flow uses link X and one of links A, B, C or D.

The effectiveness of the step-change algorithm described above is tested on the network of FIG. 7. When a new flow first transmits a request packet through the network, the links on detecting the arrival of the request packet, perform the step-change algorithm to make room at the respective resources for the new flow. After one round-trip time the source of the flow receives back acknowledgement of the request packet and starts transmitting at the rate that is conveyed back. This procedure allows a new flow to reach equilibrium within one round trip time.

In a first scenario, there is a 50% increase in flows, i.e. on each of the links A, B, C and D, there are 10 new flows that arrive and request to enter the network. So, for example, a request packet originating from flows entering link A, would first go through link A, then link X before returning to the source. In a second scenario, there is a 100% increase in flows.

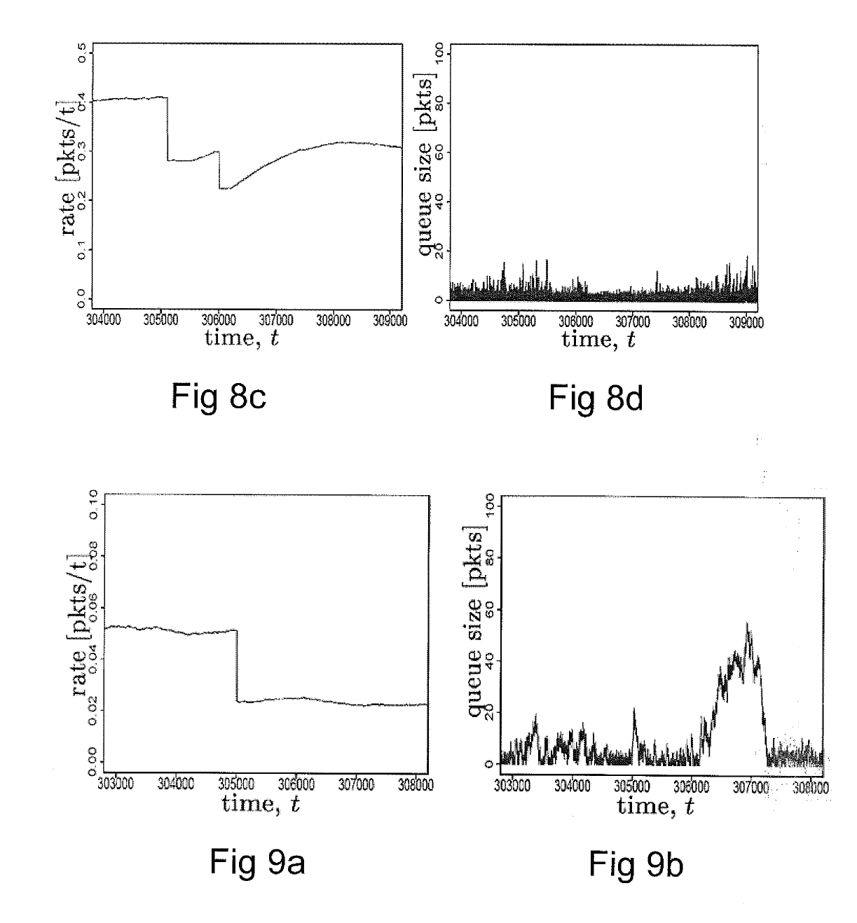

The necessary step-change required to accommodate the new flows is clearly visible at t=30500 on link C in FIG. 8a. Furthermore, as shown in FIG. 8b, there is a spike in the evolution of the queue in link C approximately 1100 time units after t=30500. 1100 time units is the sum of the physical propagation delays along links C and X. As shown in FIG. 8c, there are two step changes on link X; the first step-change is a reaction to the flows originating from links A and B and a second step-change reacting to the flows originating from links C and D.

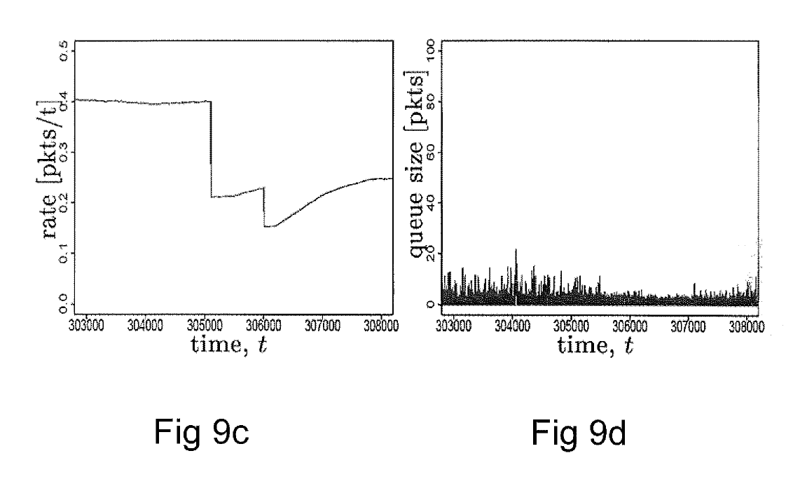

FIGS. 9a to 9d show the scenario when there is a 100% increase in flows. The step changes in rate shown in FIGS. 9a and 9c are again visible and are more pronounced. Similarly, the spike in evolution of the queue is visible in FIG. 9b and is more pronounced.

Both scenarios illustrate the effectiveness of the step change algorithm.

It is also possible to demonstrate that the step change algorithm model is robust to large, sudden increases in the number of flows.

Consider the case where the network consists of a single link j with equilibrium flow rate yⱼ. If there are n identical flows, then at equilibrium Rⱼ=yⱼ/n . When a new flow begins, the step-change algorithm is performed and Rⱼ becomes Rⱼ^{new}=yⱼ/(n+1) . Thus, equilibrium is maintained.

Now suppose that m new flows begin at the same time. Once the m flows have begun, Rⱼ should approach y ⱼ/(n+m) . However, each new flow's request for bandwidth will be received one at a time. Thus, the new flows will be given rates

yⱼ(n+1), yⱼ/(n+2), . . . , yⱼ/(n+m).

So, when the new flows start transmitting, after one round-trip time, the new aggregate rate through j, yⱼ^{new} will approximately be

$${y}_{j}^{new} \approx n \frac{{y}_{j}}{n + m} + {\int }_{n}^{n + m} \frac{{y}_{j}}{u} d u .$$

If we let ε=m/n, we have

$${y}_{j}^{new} \approx {y}_{j} ( \frac{1}{1 + ɛ} + log ( 1 + ɛ ) ) .$$

Thus, for the admission control process to be able to cope when the load is increased by a proportion ε, we simply require yⱼ^{new} to be less than the capacity of link j . Direct calculation shows that if the equilibrium value of yⱼ is equal to 90% of capacity, the last equation above allows an increase in the number of flows of up to 66% . Furthermore, if at equilibrium yⱼ is equal to 80% of capacity, then the increase in the number of flows can be as high as 120% without yⱼ^{new} exceeding the capacity of the link.

Although the above analysis and discussion revolves around a single link, it does provide a simple rule of thumb guideline for choosing parameters such as bⱼ or Cⱼ. If one takes ε to be the largest plausible increase in load that the network should be able to withstand, then from the last equation above, one can calculate the value of yⱼ which gives yⱼ^{new} equal to capacity. This value of yⱼ can then be used to choose bⱼ or Cⱼ, using the equilibrium relationship Cⱼ−yⱼ=bⱼCⱼpⱼ(yⱼ).

For completeness, the conditions for the local stability of the system of delayed differential equations particularly for the revised RCP algorithm are derived below. It is assumed that the |J|×|R| connectivity matrix A , which has entry Aⱼᵣ=1 if jεr and Aⱼᵣ=0 otherwise, has full row rank. This is a common, and weak, assumption (see F. Kelly. Fairness and stability of end-to-end congestion control. European Journal of Control, 9:159-176, 2003 and R. Srikant. The Mathematics of Internet Congestion Control. Birkhauser, 2004).

First we establish that the relevant equations have a unique equilibrium. We shall assume that pⱼ(·) is an increasing function, for jεJ , as it is for the special case defined above. Hence there is a unique value of yⱼ(t) , call it such that the derivative d/dt (Rⱼ) is zero.

Let Y=(Yⱼ, jεJ) . Given Y, consider the problem of choosing x=(xᵣ, rεR) in order to

$$maximize {\sum }_{r ∈ R} {w}_{r} U ( {x}_{r} )$$

$$over Ax \leq Y , x \geq 0 , \\ where α > 0 and$$

$$\begin{matrix}U ( x ) = \frac{{x}^{1 - α}}{1 - α} α \neq 1 \\ = log ( x ) α = 1.\end{matrix}$$

The unique solution to this strictly convex optimization problem is called a weighted α-fair rate allocation, or, if wᵣ=1, rεR , an α-fair rate allocation (see F. Kelly. Fairness and stability of end-to-end congestion control. European Journal of Control, 9:159-176, 2003, J. Mo and J. Walrand. Fair end-to-end window-based congestion control. IEEE/ACM Transactions on Networking, 8:556-567, 2000 and R. Srikant. The Mathematics of Internet Congestion Control. Birkhauser, 2004).

We can identify the stationary version

$${x}_{r} = {{w}_{r} ( {\sum }_{j ∈ r} {R}_{j}^{- α} )}^{- 1 / α}$$

of the flow rate previously defined with the unique optimum to the problem above: (Rⱼ^{-α}, jεJ) is simply the vector of Lagrange multipliers for the constraints Ax≦Y. Since A is of full row rank, this vector is unique.

Next, we linearise the system about its unique equilibrium. Let Rⱼ denote the equilibrium value of Rⱼ(t) for each jεJ , and let xᵣ be the equilibrium value of xᵣ(t) for each rεR . Taking Rⱼ(t)=Rⱼ+Rⱼvⱼ(t), for all jεJ , we get the following linearised version

$${\dot{v}}_{j} ( t ) = - \frac{{a}_{j} ( {Y}_{j} + {C}_{j} )}{{C}_{j} {Y}_{j} {\overline{T}}_{j}} {\sum }_{r : j ∈ r} \frac{{x}_{r}^{α + 1}}{{w}_{r}^{α}} {\sum }_{l ∈ r} {R}_{l}^{- α} {v}_{l} ( t - {τ}_{lr} - {τ}_{rj} ) .$$

To reduce to this form, we have used the result (Yⱼ+Cⱼ)/Yⱼ=1+bⱼCⱼpⱼ(Yⱼ).

Let us define

$${z}_{r} ( t ) = {x}_{r} {T}_{r} {\sum }_{j ∈ r} {R}_{j}^{- α} {v}_{j} ( t - {τ}_{jr} )$$

$$for each r ∈ R . Then we get$$

$${\dot{v}}_{j} ( t ) = - \frac{{a}_{j} ( {Y}_{j} + {C}_{j} )}{{C}_{j} {Y}_{j} {\overline{T}}_{j}} {\sum }_{r : j ∈ r} \frac{{x}_{r}^{α}}{{w}_{r}^{α} {T}_{r}} {z}_{r} ( t - {τ}_{rj} )$$

$$and$$

$${\dot{z}}_{r} ( t ) = - {x}_{r} {T}_{r} {\sum }_{j ∈ r} {R}_{j}^{- α} \frac{{a}_{j} ( {Y}_{j} + {C}_{j} )}{{C}_{j} {Y}_{j} {\overline{T}}_{j}} {\sum }_{s : j ∈ s} \frac{{x}_{s}^{α}}{{w}_{s}^{α} {T}_{s}} {z}_{s} ( t - {τ}_{sj} - {τ}_{jr} ) .$$

If the last equation is exponentially stable, then, from the previous equation, \dot{v}(t) must tend to 0 exponentially and so v(t) must tend to a limit. However, z(t) →0 and the connectivity matrix has full row rank, and so, from the equation for z(t), we must have v(t) →0.

To find conditions for the exponential stability of the last equation we turn to control theory. Let us overload notation and write z(ω) for the Laplace transform of z(t) . A natural control loop version of this equation is:

z(ω)=X(ω)P(ω)K(ω)(w(ω)−z(ω)),

where X(ω), P(ω) and K(ω) are matrix functions, defined below, and w(ω) represents the input into the control loop.

We define X(ω) and K(ω) to be diagonal matrices with entries

$${X}_{r , r} ( ω ) = {T}_{r} {e}^{- {T}_{r} ω} {x}_{r}^{1 - α} {w}_{r}^{α} , {K}_{r , r} ( ω ) = \frac{1}{T , ω} .$$

The matrix P(ω) has entries

$${P}_{r , s} ( ω ) = {e}^{ω ( {τ}_{rj} - {τ}_{sj} )} \frac{{x}_{r}^{α} {x}_{s}^{α}}{{w}_{r}^{α} {w}_{s}^{α}} {\sum }_{j ∈ r ⋂ s} {R}_{j}^{- α} \frac{{a}_{j} ( {Y}_{j} + {C}_{j} )}{{C}_{j} {Y}_{j} {\overline{T}}_{j}} ,$$

and thus satisfies P^{T}(−ω)=P(ω) . Theorem 1 of G. Vinnicombe “On the stability of end-to-end congestion control for the Internet” in Cambridge University Engineering Department Technical Report CUED/F-INFENG/TR.398 2000 implies that natural control loop version of the equation is asymptotically stable. Accordingly, the previous equation is exponentially stable, if the maximum absolute row sum norm of P(iθ)X(0) is less than π/2 for all real θ. For any real θ, the maximum absolute row sum norm of P(iθ)X(0) is given by

$${‖ P ( i θ ) X ( 0 ) ‖}_{∞} = {max}_{r ∈ R} \frac{{x}_{r}^{α}}{{w}_{r}^{α}} {\sum }_{j ∈ r} {R}_{j}^{- α} \frac{{a}_{j} ( {Y}_{j} + {C}_{j} )}{{C}_{j} {Y}_{j} {\overline{T}}_{j}} {\sum }_{s : j ∈ s} {x}_{s} {T}_{s} \leq {max}_{r ∈ R} {( {\sum }_{l ∈ r} {R}_{l}^{- α} )}^{- 1} {\sum }_{j ∈ r} {R}_{j}^{- α} {max}_{l ∈ J} {a}_{l} \frac{{Y}_{l} + {C}_{l}}{{C}_{l}} \leq 2 {max}_{j ∈ J} {a}_{j} .$$

Thus, if, for all jεJ, αⱼ<π/4, then the system of delayed differential equations for the revised RCP algorithm is locally stable about its unique equilibrium point.

In the above description, terms like max-min fairness, proportional fairness and others that are not explained are currently known to researchers in the field, see see F. Kelly. Fairness and stability of end-to-end congestion control. European Journal of Control, 9:159-176, 2003, for further references.

The invention described above proposes an admission control process which offers a high starting rate for new flows and does not require buffer sizing rules to depend on network parameters like the capacity and the round-trip times. In fact as a consequence of the proposed processes buffer sizes can be small; even to the order of 20 to 100 packets. To achieve the above objective, we specify processes involving a step-change in the congestion control feedback variable that will approximately allow a resource to accommodate a new flow. In the proposed admission process knowledge of individual flow rates is not required. Rather, the step-change in the feedback variable could use quantities like an estimate of the aggregate flow through the resource, or constants like the capacity of the resource.

A communications network may have a family of different equilibrium structures which allocate resources according to different notions of fairness. The proposed admission control process does not need to be aware of the equilibrium fairness criteria adopted by the network. However, the processes appear to be very appealing, and a natural choice, in the case of proportional fairness.

No doubt many other effective alternatives will occur to the skilled person. It will be understood that the invention is not limited to the described embodiments and encompasses modifications apparent to those skilled in the art lying within the spirit and scope of the claims appended hereto.

1. A router for a communication network comprising at least one source and at least one destination with a plurality of data flows from said at least one source to said at least one destination, said router comprising a processor which is configured to
store local information relating to said router at said router;
determine, using said stored local information, an internal feedback variable indicative of congestion at said router;
detect a new data flow to the router;
determine, using said stored local information and said internal feedback variable, an adjustment to said internal feedback variable to accommodate said new flow; and
communicate data representing said adjusted internal feedback variable to said source of said new flow and to sources of existing data flows, whereby said sources of existing data flows adjust their flow rates so that there is a reduction in the aggregate flow rate of sources of existing data flows to accommodate said new flow.

2. A router according to claim 1, wherein said processor is configured to detect a weight allocated to said new flow and to determine any required adjustment to said internal feedback variable based on said allocated weight.

3. A router according to claim 2, wherein said processor is configured to detect any change in a weight allocated to any data flow and to determine any required adjustment to said internal feedback variable based on said change in allocated weight.

4. A router for a communication network comprising at least one source and at least one destination with a plurality of data flows from said at least one source to said at least one destination, said router comprising a processor which is configured to
store local information relating to said router at said router;
determine, using said stored local information, an internal feedback variable indicative of congestion at said router;
detect a change in a weight allocated to a data flow;
determine, using said stored local information and said internal feedback variable, an adjustment to said internal feedback variable to accommodate said detected change; and
communicate data representing said adjusted internal feedback variable to said sources, whereby said sources having unchanged weight adjust their flow rates so that there is a change in the aggregate flow rate to accommodate any change in flow rate corresponding to said detected change in weight.

5. A router according to claim 4, wherein said detected change is an increase in an allocated weight for an existing flow.

6. A router according to claim 4, wherein said detected change is a new flow to said router.

7. The router according to claim 4, wherein said processor is configured to adjust said internal feedback variable whereby said changed weighted flow goes through successive increases to achieve said change.

8. A router according to claim 7, wherein said successive increases in flow weight occur at regular intervals of once per round trip time.

9. The router according to claim 4, wherein said local information includes an estimate of the aggregate flow rate.

10. A router according to claim 9, wherein said estimate of aggregate flow rate is a weighted exponential average of data arriving at said router.

11. A router according to claim 9, wherein said estimate of aggregate flow rate is a fixed proportion of the bandwidth of said router.

12. The router according to claim 4, wherein said local information includes the bandwidth of the router.

13. The router according to claim 4, wherein said local information includes one or more of an estimate of mean queue length of data packets queueing in a buffer at the router or a virtual queue maintained at said router.

14. The router according to claim 4, wherein said local information includes an estimated measure of responsiveness of said local information to changes in said internal feedback variable.

15. The router according to claim 4, wherein said local information is derived by aggregating information transmitted by the data flows in packet headers.

16. The router according to claim 4, wherein said reduction or change in said aggregate flow rate approximates to an estimate of the flow rate required by said new flow.

17. A router according to claim 16, wherein said estimated flow rate is calculated from an average of flow rates of all existing data flows at said router.

18. The router according to claim 4, wherein said change in said aggregate flow rate approximates to an estimate of the flow rate required by said flow undergoing said detected change in weight.

19. A router according to claim 18, wherein said estimated flow rate is an estimate of a flow rate for a typical new flow of weight equal to said weight increase.

20. The router according to claim 1, wherein said internal feedback variable is defined as the inverse of an internal variable Rⱼ(t) where the rate of change of Rⱼ(t) with time is a function of
$$\frac{{R}_{j} ( t )}{{C}_{j} {\overline{T}}_{i} ( t )} ( {C}_{j} - {y}_{j} ( t ) )$$
and yⱼ(t) is the aggregate load at router j, T̅ⱼ(t) is the average round trip time of data passing through router and Cⱼ is the capacity of the router.

21. A router according to claim 20, wherein said adjustment to said internal feedback variable is applied by setting the internal variable Rj as equal to
$${R}_{j}^{new} = {R}_{j} \cdot \frac{{y}_{j}}{{y}_{j} + {R}_{j}} or {R}_{j}^{new} = {R}_{j} \frac{{y}_{j}}{{y}_{j} + {wR}_{j}}$$
where w is a change of weight associated with a data flow.

22. The router according to claim 1, wherein said internal feedback variable is defined as μⱼ(t) where the rate of change with time is a function of
μⱼ(t)(Cⱼ−yⱼ(t))
and yⱼ(t) is the aggregate load at link j and Cⱼ is the capacity of the router.

23. (canceled)

24. A method of managing flow through a router on a communication network comprising at least one source and at least one destination with a plurality of data flows from said at least one source to said at least one destination, said method comprising
storing local information relating to said router at said router;
determining, using said stored local information, an internal feedback variable indicative of congestion at said router;
detecting a new data flow to the router;
determining, using said stored local information and said internal feedback variable, an adjustment to said internal feedback variable to accommodate said new flow; and
communicating data representing said adjusted internal feedback variable to said source of said new flow and to sources of existing data flows, whereby said sources of existing data flows adjust their flow rates so that there is a reduction in the aggregate flow rate of sources of existing data flows to accommodate said new flow.

25. A method according to claim 24, wherein said reduction or change in said aggregate flow rate approximates to an estimate of the flow rate required by said new flow.

26. A method of managing flow through a router on a communication network comprising at least one source and at least one destination with a plurality of data flows from said at least one source to said at least one destination, said method comprising
storing local information relating to said router at said router;
determining, using said stored local information, an internal feedback variable indicative of congestion at said router;
detecting a change in a weight allocated to a data flow;
determining, using said stored local information and said internal feedback variable, an adjustment to said internal feedback variable to accommodate said detected change; and
communicating data representing said adjusted internal feedback variable to said sources, whereby said sources having unchanged weight adjust their flow rates so that there is a change in the aggregate flow rate to accommodate any change in flow rate corresponding to said detected change in weight.

27. A method according to claim 26, comprising adjusting said internal feedback variable so that said changed weighted flow goes through successive increases to achieve said change.

28. The method according to claim 26, wherein said change in said aggregate flow rate approximates to an estimate of the flow rate required by said flow undergoing said detected change in weight.

29-40. (canceled)

41. The method according to claim 27, wherein said change in said aggregate flow rate approximates to an estimate of the flow rate required by said flow undergoing said detected change in weight.

42. The router according to claim 22, wherein said adjustment to said internal feedback variable is applied by setting the internal variable Rj as equal to
$${R}_{j}^{new} = {R}_{j} \cdot \frac{{y}_{j}}{{y}_{j} + {R}_{j}} or {R}_{j}^{new} = {R}_{j} \frac{{y}_{j}}{{y}_{j} + {wR}_{j}}$$
where w is a change of weight associated with a data flow

43. The router according to claim 4, wherein said internal feedback variable is defined as the inverse of an internal variable Rⱼ(t) where the rate of change of Rⱼ(t) with time is a function of
$$\frac{{R}_{j} ( t )}{{C}_{j} {\overline{T}}_{j} ( t )} ( {C}_{j} - {y}_{j} ( t ) )$$
and yⱼ(t) is the aggregate load at router j, T̅ⱼ(t) is the average round trip time of data passing through router and Cⱼ is the capacity of the router.

44. The router according to claim 43, wherein said adjustment to said internal feedback variable is applied by setting the internal variable Rj as equal to
$${R}_{j}^{new} = {R}_{j} \cdot \frac{{y}_{j}}{{y}_{j} + {R}_{j}} or {R}_{j}^{new} = {R}_{j} \frac{{y}_{j}}{{y}_{j} + {wR}_{j}}$$
where w is a change of weight associated with a data flow

45. The router according to claim 4, wherein said internal feedback variable is defined as μⱼ(t) where the rate of change with time is a function of
μⱼ(t)(Cⱼ−yⱼ(t))
and yⱼ(t) is the aggregate load at link j and Cⱼ is the capacity of the router.

46. The router according to claim 45, wherein said adjustment to said internal feedback variable is applied by setting the internal variable Rj as equal to
$${R}_{j}^{new} = {R}_{j} \cdot \frac{{y}_{j}}{{y}_{j} + {R}_{j}} or {R}_{j}^{new} = {R}_{j} \frac{{y}_{j}}{{y}_{j} + {wR}_{j}}$$
where w is a change of weight associated with a data flow.
